(19) United States
(12) Patent Application Publication
(10) Pub. No.: US 2011/0242451 A1
(43) Pub. Date: Oct. 6, 2011

(54) Beam Multiplier for Multi-LED Lighting Assemblies

(76) Inventor: Gerhard Albert Koepf, Boulder, CO (US)

(21) Appl. No.: 13/012,061

(22) Filed: Jan. 24, 2011

Related U.S. Application Data
(63) Continuation-in-part of application No. 12/754,781, filed on Apr. 6, 2010.

(51) Int. Cl. G02F 1/1335; G02B 5/32; G02F 1/01

(52) U.S. Cl. 349/61; 359/15

(57) ABSTRACT

A beam multiplier operates on lighting assemblies using light emitting diodes (LED) to make their appearance and their illumination field more uniform. It uses holographic structures to multiply the number of light beams emitted by the LEDs. Fixed or switched holographic structures can be used in the construction of beam multipliers. Beam multipliers with electrically switched holographic structures fabricated of liquid crystal materials provide lighting assemblies with selectable static or dynamic modes of operation such as beam widening and sharpening modes, color changing modes and scanning modes.

### BACKGROUND

Light emitting diodes (LED) are replacing conventional light sources in a rapidly growing number of lighting applications. LED sources fabricated for lighting applications generate diverging LED beams with a bell shaped cross section and a typically 20-40 degree width. The luminescence of a single LED source is insufficient for many lighting applications. Manufacturers increase the luminescence by using a plurality of LED sources. The invention relates to lighting assemblies using such multi-LED sources for fixed mounted and mobile lighting applications.

### BRIEF DESCRIPTION

Lighting assemblies are designed to distribute light over a specific illumination field. Lighting manufacturers arrange groups of LED sources in one or three-dimensional geometries conforming to planar or curved surfaces. Light bulb replacements or other lighting assemblies using groups of LED sources have an illumination field that is the non-coherent superposition of the constituent LED beams. The resulting brightness variations across the illumination field are perceived as hot spots and are undesirable in many lighting applications. For example, when groups of LED sources are used in desk lamps or flash lights as replacements for conventional light bulbs, the non-uniform illumination makes it more difficult to view objects in the illumination field. Furthermore, when looking at such lighting assemblies, viewers perceive the geometrically separated LED sources as hot spots with high luminescence.

Traditional methods to provide a more uniform appearance of light fixtures and a more uniform brightness in the illumination field include the use of light diffusing and/or light scattering materials placed in front of the multi-LED source. These methods may be suitable in lighting applications that require a illumination field greater than 2*Pi steradian. They are less effective in lighting applications requiring a smaller illumination field.

The invention introduces an alternative method to improve the appearance and the brightness uniformity over the illumination field of lighting assemblies using multiple-LED light sources. The method uses a beam multiplier that generates two or more deflected LED beams from each incident LED beam. The deflected beams generated by the beam multiplier may have substantially the same beam divergence and cross section as the incident LED beam, but propagate at an angle relative to the axis of the incident LED beam. They may also have a different beam divergence. When positioned in the beam of a single LED source, the beam multiplier can create the perception of a light source comprised of a number of less luminous virtual LED sources separated from each other. When positioned in front of a multi-LED source, the beam multiplier multiplies the number of hot spots, thereby generating a substantially more uniform illumination field.

The invention further introduces a method to actively control beam multiplier characteristics, such as the beam multiplication factor, the beam divergence and the beam deflection angles. Switched beam multipliers afford light assemblies the ability of being operated in different modes of operation. These modes of operation can be used to provide a range of lighting scenarios from a single lighting assembly without moving parts.

### DESCRIPTION OF FIGURES

FIG. 1. Side view of an LED transmitting an LED beam and an observer looking at the brightness profile in the illumination field.

FIG. 2. Brightness profile of a linear array of three LEDs showing three hot spots in the illumination field.

FIG. 3A. Side view showing a beam multiplier with a multiplication factor of two operating on a single incident LED beam; an observer perceives the number of LED sources and the number of hot spots multiplied by two.

FIG. 3B. Side view showing a beam multiplier with a multiplication factor of three operating on a single incident LED beam; an observer perceives the number of LED sources and the number of hot spots multiplied by three.

FIG. 4. Side view showing a beam multiplier with a multiplication factor of two, operating on three incident LED beams transmitted by a linear array of three LED sources.

FIG. 5. Side view of two cascaded beam multipliers, each with a multiplication factor of two, operating on an incident LED beam and generating four deflected beams represented by their beam axes.

FIG. 6A. Appearance of a linear array of seven LED sources when operated on by two cascaded beam multipliers with multiplication factors of two and equal deflection angles; one beam multiplier is oriented along the axis, and the other beam multiplier is oriented perpendicular to the axis of the linear array, respectively.

FIG. 6B. Appearance of a linear array of seven LED sources when operated on by two cascaded beam multipliers with multiplication factors of two and equal deflection angles; one beam multiplier is oriented at positive 45 degrees and the other beam multiplier is oriented at negative 45 degrees to the axis of the linear array, respectively.

FIG. 7A. An assembly view of a switched beam multiplier comprised of a liquid crystal material between two transparent plates with transparent electrodes with control leads.

FIG. 7B. An assembly view of a switched beam multiplier comprised of two fixed holographic polarization structures and a liquid crystal half wave switch.

FIG. 8A. A switched beam multiplier electrode pattern with two concentric multiplier zones, control leads, wire bundle and zone controller.

FIG. 8B. A switched beam multiplier electrode pattern with nine square multiplier zones, control leads, connecting wire bundles, and zone controller.

### DETAILED DESCRIPTION

1. Beam Multiplier Operation

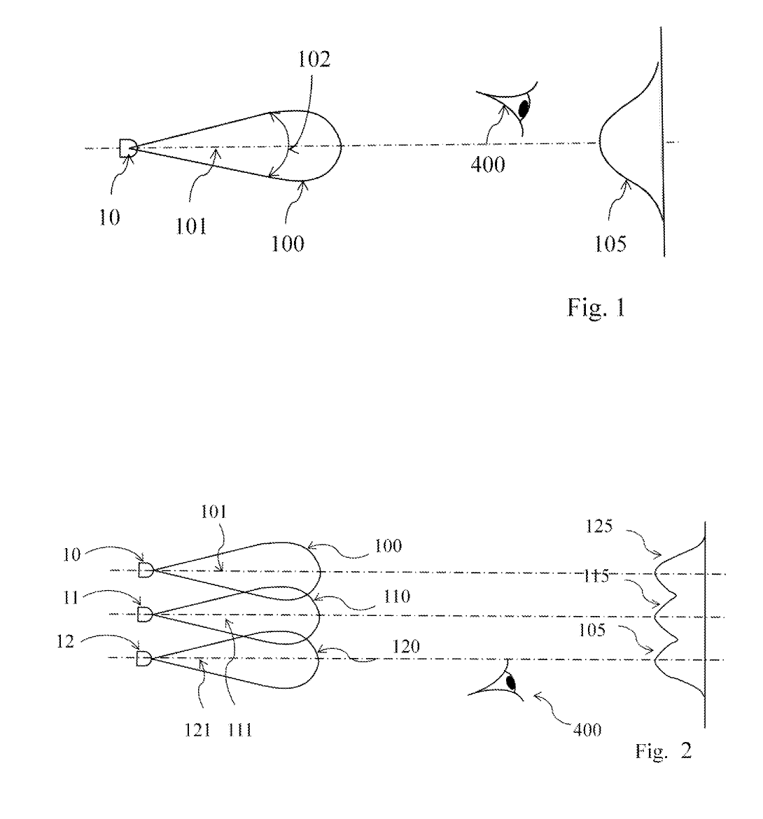

The following discussion presents a more detailed description of the operation of a beam multiplier for use in multi-LED lighting assemblies. FIG. 1 shows a single LED source 10 transmitting LED beam 100 with beam axis 101 and beam width 102. The far field of LED beam 100 has a bell shaped brightness cross section 105. Viewer 400 observes the illumination field of this LED beam as a single hot spot. When two or more LED sources are grouped together in a light fixture the appearance of hot spots is more apparent. FIG. 2 shows three LED sources arranged in a linear array: LED source 10 transmits LED beam 100 with beam axis 101, LED source 11 transmits LED beam 110 with beam axis 111, and LED source 12 transmits LED beam 120 with beam axis 121. Observer 400 in FIG. 2 perceives the illumination field as comprised of three hot spots, hot spot 105, hot spot 115, and hot spot 125.

The invention aims at reducing or eliminating the appearance of hot spots in the illumination field of such multi-LED lighting assemblies. This is accomplished by positioning a beam multiplier in front of the multi-LED source providing a beam multiplication factor, a beam divergence factor, one or more beam deflection angles, and a deflection efficiency for deflected LED beams. The beam multiplication factor determines the number of deflected beams generated by the beam multiplier for each incident LED beam. The beam divergence factor determines the focusing or defocusing of deflected LED beams. The one or more beam deflection angles relate to the propagation axes of deflected LED beams. The deflection efficiency characterizes the brightness reduction of deflected LED beams relative to the brightness of the incident LED beam.

The use of the beam multiplier is neither limited to any specific geometrical arrangement of LED sources nor any specific kind of LED source in the multi-LED lighting assembly. It may be used in lighting assemblies comprising white light sources, single color LED sources, or a mix of color and/or white light LED sources.

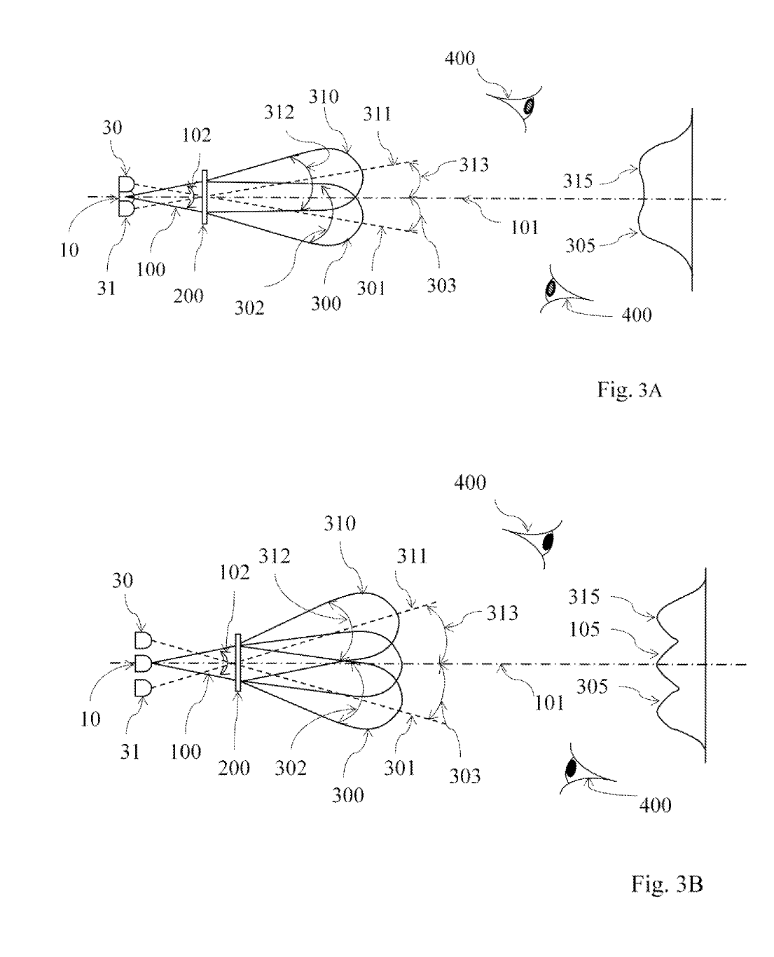

FIG. 3A shows an example were beam multiplier 200 with a multiplication factor of two, zero divergence factor (no defocusing), deflection angle alpha and 50 percent deflection efficiency for both deflected beams operates on single LED source 10, with LED beam 100 having a beam axis 101 and a beam width 102. Beam multiplier 200 modifies the appearance of the light source to an observer, effectively generating the perception that single LED 10 has been replaced by virtual LED sources 30 and 31, each with V2 the brightness of real LED source 10. First deflected LED beam 300 has beam axis 301, beam width 302 and beam deflection angle 303 with respect to LED beam axis 101; and second deflected LED beam 310 has beam axis 311, beam width 312 and beam deflection angle 313 with respect to LED beam axis 101. Beam widths 302 and 312 are the same as beam width 102. Deflection angles 303 and 313 are the same, but have opposite signs with respect to beam axis 101, and are equal to beam multiplier deflection angle alpha. An observer of the far field of this LED source when modified by the beam multiplier perceives two hot spots, hot spots 305 and 315.

FIG. 3B shows a second example using a multiplication factor of three, zero divergence factor, deflection angle alpha, and a deflection efficiency of 33 percent for each of the three deflected beams. Beam multiplier 200 deflects incident LED beam 100 with zero deflection angle. Second deflected beam 300 has beam axis 301, beam width 302 and deflection angle 303, and third deflected beam 310 has beam axis 311, beam width 312 and deflection angle 313. Observer 400 in the far field perceives three hot spots: hot spot 105 comes from real LED source 10, hot spot 305 comes from virtual LED source 30 and hot spot 315 comes from virtual LED source 31. Observer 400 perceives an illumination field that is essentially identical to a light source comprising three LED sources shown in FIG. 2.

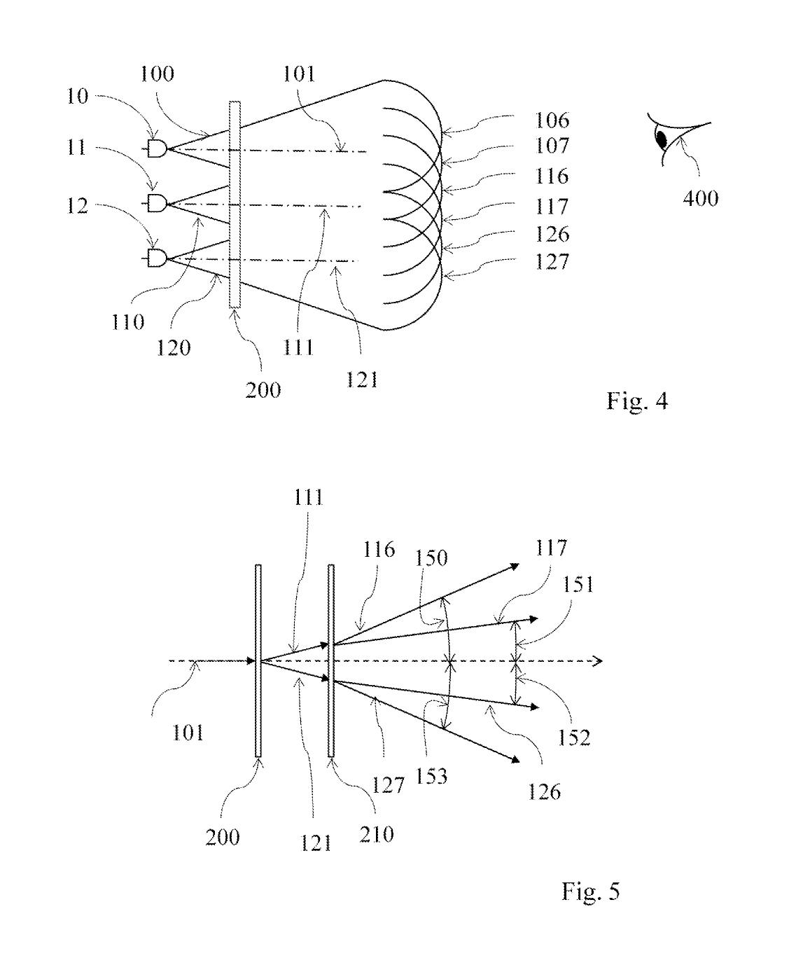

As an example of operating a beam multiplier with a linear array of LED sources, FIG. 4 shows a section of a linear array of LED sources comprised of three essentially identical LED sources spaced by distance D. LED sources 10, 11 and 12 transmit diverging beams 100, 110 and 120 with beam axes 101, 111 and 121, respectively. Beam multiplier 200 has a multiplication factor of 2, zero divergence factor, deflection angle alpha and near 50 percent diffraction efficiency for each deflected beam. It is oriented such that beam multiplication occurs in the plane that encompasses the linear array and the beam axes 101, 111 and 121.

Furthermore, beam multiplier 200 is positioned at a distance d from the LED sources such that LED beams 100, 110 and 120 do not substantially overlap in the plane of the beam multiplier. Beam multiplier 200 multiplies beams 100, 110 and 120 into six beams with half the brightness of the incident beams. Deflected beams 106, 116 and 126 propagate at the deflection angle alpha to one side, and deflected beams 107, 117 and 127 propagate at the deflection angle alpha to the opposite side, relative to beam axes 101, 111 and 121, respectively. To an observer of the array comprised of three real LED sources, the array appears to be comprised of six virtual LED sources. Likewise, the number of hot spots in the far field has doubled from three to six, and each of the six hot spots has a brightness that is reduced by one half compared to the brightness of the hotspots generated by the array of real LED sources.

The relative spacing Dv of virtual LED sources generated by the beam multiplier depends on the spacing D of the real LED sources in the array, the distance d between the LED array and the beam multiplier, and the beam multiplier deflection angle alpha. For the special case, where alpha=arctan D/(4*d), Dv=D/2. The observer perceives a illumination field as provided by a light fixture with twice the number of LED sources equally spaced by Dv=D/2, but with half the brightness of the real LED sources.

Alternatively, when beam multiplier 200 in FIG. 4 is oriented such that beam multiplication happens in the orthogonal direction to the plane encompassing the LED array, the appearance of the array changes to one where pairs of virtual LED sources spaced by distance Dv=d*tan(alpha) orthogonal to the array axis are spaced by distance D in the array axis.

In these examples, beam multipliers with multiplication factors of two and three were used to illustrate the basic method of beam multiplication. It follows, that beam multipliers with larger multiplication factors, more than one deflection angle, more than one orientation, and a range of deflection efficiencies can be operated in substantially the same way as shown in the examples to provide further improvements in the appearance of the light assemblies and in their brightness uniformity over the illumination field.

Further, it follows that higher multiplication factors can be realized by using two or more cascaded beam multipliers each having a low multiplication factor. FIG. 5 shows an example of operating two cascaded beam multipliers operating on a LED beam. For clarity, cascaded beam multiplier 200 and 210 are shown separated by a distance. Incident as well as deflected beams are represented by their beam axes only.

First beam multiplier 200 has a multiplication factor of two, zero divergence factor, deflection angle alpha and deflection efficiency of 50 percent. Second beam multiplier 210 has a multiplication factor of two, zero divergence factor, deflection angle beta, deflection efficiency of 50 percent and is positioned in close proximity to beam multiplier 200. Beam multipliers 200 and 210 are assumed to have the same orientation. Incident LED beam with beam axis 101 is multiplied by beam multiplier 200 into two deflected beams with beam axes 111 and 121 at deflection angle alpha. Each of these deflected beams is incident on second beam multiplier 210.

The combined action of cascaded beam multipliers 200 and 210 is a multiplication of incident LED beam into four deflected beams with beam axes 116, 117, 126 and 127. Beam axis 116 is deflected by angle 150, equal to alpha+beta with respect to axis 101, beam axis 117 is deflected by angle 151 equal to alpha−beta with respect to axis 101, beam axis 126 is deflected by angle 152 equal to −alpha+beta with respect to angle 101, and beam axis 127 is deflected by angle 153 equal to −alpha−beta with respect to beam axis 101. The four deflected beams have a substantial brightness equal to ¼ of the incident beam.

When applied to a one-dimensional array of LED sources equally spaced by distance D, the cascaded beam multiplier in FIG. 5 may be used to change the appearance of the light source to one comprising four times the number of LED sources equally spaced by D/4. This is achieved with both cascaded beam multipliers oriented in the same direction, when the first cascaded beam multiplier has a deflection angle alpha equal to arctan (D/(4*d1)) and second cascaded beam multiplier has deflection angle beta equal to arctan(D/(8*d2)), where d1 is the distance between the LED sources and the first beam multiplier and d2 is the distance between the LED sources and the second beam multiplier.

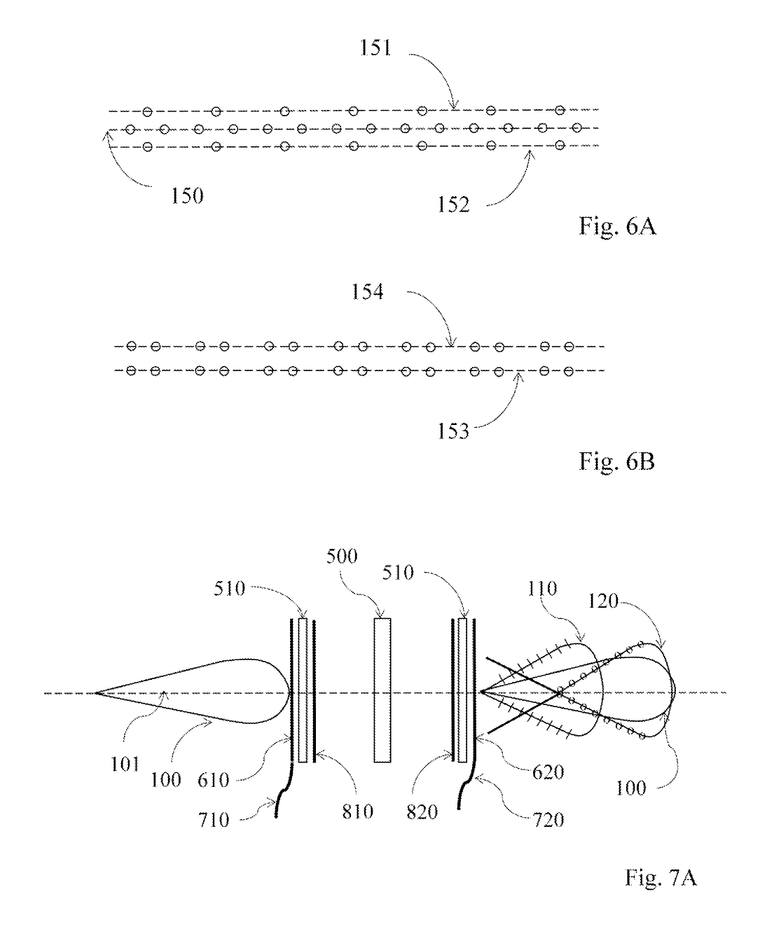

Alternatively, the two cascaded beam multipliers may be oriented in orthogonal directions for generating a light source where four virtual LED sources replace every real LED source in a variety of patterns. FIGS. 6A and 6B shows two such patterns where LED sources are represented by small circles. In FIG. 6A the first of the two cascaded beam multipliers is oriented to generate deflected beams in the plane containing the single row of real LED sources and the second cascaded beam multiplier is oriented to generate deflected beams in an orthogonal plane. The virtual array generated by this beam multiplier has the appearance of a two-dimensional array with additional rows 151 and 152, each with the same number of virtual LED sources as the real number of LED sources, while row 150 has twice the number of virtual LED sources. In FIG. 6B, the two orthogonally oriented cascaded beam multipliers are oriented to generate deflected beams in planes tilted at 45 degrees relative to the plane containing axis 150. The virtual array generated by this orientation of cascaded beam multipliers has the appearance of two rows of LED sources 153 and 154, each with twice the number of virtual LED sources compared to the number of real LED sources in the array.

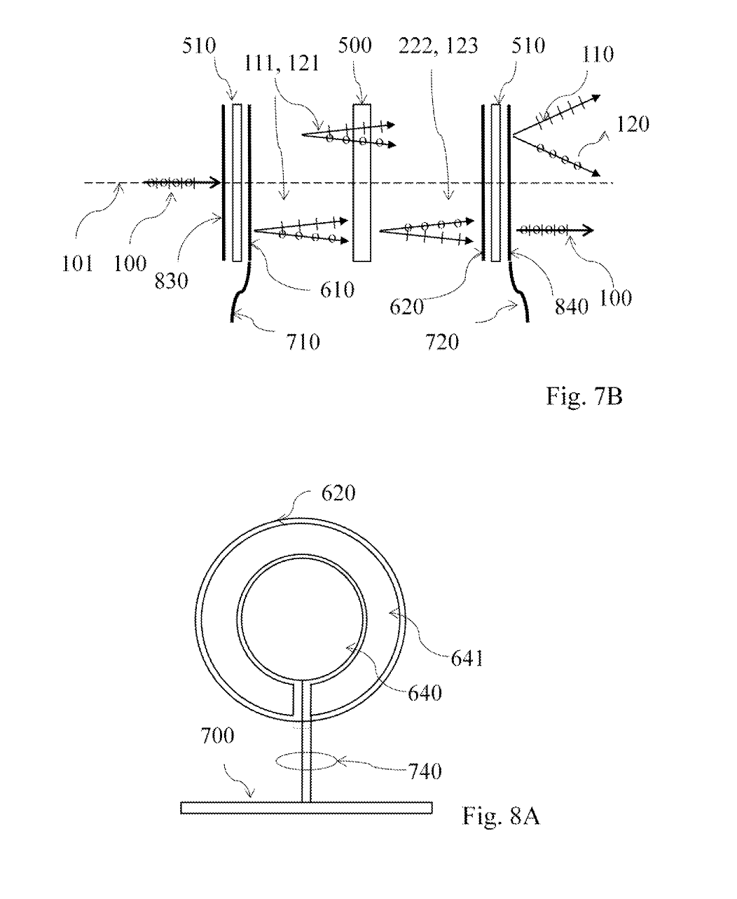

From these examples one may project the use of single or cascaded beam multipliers in lighting assemblies using multi-LED sources arranged in two dimensions. By selecting the multiplication factors, the deflection angles and the orientations of the cascaded beam multipliers, the appearance of the lighting assembly and the field or regard may be controlled in a wide range of patterns. In extension of the example shown in FIG. 7B, two orthogonally oriented cascaded beam multipliers operating on a square grid of LED sources with spacing D may be used to generate a square grid of virtual LED sources. The virtual LED grid is rotated by 45 degrees and the grid spacing of the virtual LED sources is equal to D/√2 if the deflection angles of the two cascaded beam multipliers are equal to arctan(D*√2/(4*d)).

The spacing of the virtual LED sources relative to the real LED sources for a given beam multiplier deflection angle increases with distance d between the one or more beam multipliers and the LED array. It follows that the distance d may be used as a design parameter for light assemblies using beam multipliers.

For clarity only, up to this point the presentation of operating beam multipliers in multi-LED light assemblies assumed LED beams do not essentially overlap at the location of the beam multiplier. In practice, there is no such restriction for geometrically large beam multipliers operating on a multi-LED source, as their operation at any point is independent of the origin of a particular incident LED beam. Therefore, beam multipliers that operate on a group or array of LED sources may also be placed further away from the LED sources at a position where multiple LED beams overlap.

Furthermore, distance d contributes to the depth of the light assembly. For some lighting applications, one may chose to place the beam multiplier close to the multi-LED source to achieve a low profile. In other lighting assemblies, where groups of LED sources are arranged on a curved surface, one might chose to use a separate beam multiplier for each LED source, preferentially integrating the beam multipliers with the LED source.

In other applications, beam multipliers with non-zero divergence factors may be used—alone or in combination with other beam multipliers—to focus or defocus deflected LED beams.

2. Beam Multiplier Embodiments

Beam multipliers of the invention operate differently on LED beams than other known methods used to improve the uniformity of illumination over the field or regard. These known methods use scattering and diffusing devices to distribute the LED beams over a wider illumination field. The invention allows for use of beam multipliers in combination with such scattering and diffusing methods and devices without limitation.

Persons skilled in the field of optics are familiar with optical components and devices applicable for embodiments of beam multipliers. According to the invention, beam multipliers used in multi-LED lighting assemblies preferentially operate in transmission, are planar devices, have a thin profile, and can be inexpensively fabricated in large quantities. The preferred embodiment of beam multipliers uses holographically generated structures that operate on the light phase and light polarization and do not attenuate the LED beams. The simplest such holographically generated structure is a grating, obtained by recording the interference pattern formed by the superposition of two coherent monochromatic plane waves. Furthermore, when the plane waves are circularly polarized, one obtains a holographic polarization grating. Such gratings with near 100 percent diffraction efficiencies for wideband light sources have been fabricated using liquid crystal materials and are finding applications in light projectors and for laser beam steering. (ref.: “Polarization-independent switching with high contrast from a liquid crystal polarization grating”, Michael J Escuti, W. Michael Jones, SID International Symposium, San Francisco, Calif. (Jun. 4-9, 2006).

A holographic polarization grating operates on a randomly polarized LED beam essentially as the beam multiplier shown in FIG. 3A: One polarization component is deflected into a first positive grating order and the other polarization component is deflected into a first negative grating order. The beam multiplier deflection angle is equal to the grating angle and the deflection efficiency for each of the deflected beams can be near 50 percent.

Materials for recording holographic structures include photosensitive polymers and liquid crystal materials. Polymer holograms are fabricated by deposition of the photosensitive material on a transparent substrate, exposing the polymer to a coherent interference pattern and curing. Such holographically fabricated structures can be used to make replica gratings if the structure is recorded in a surface profile.

To record not only the phase variations of the interference pattern but also the polarization variations, liquid crystals are embedded in the photosensitive polymer. Following the same fabrication process with this material and using circular polarized light during exposure produces a polarization hologram. When used in a beam multiplier application, each incident non-polarized LED beam generates two orthogonally polarized deflected beams propagating at opposite deflection angles.

Liquid crystal materials can be used to fabricate switched holographic polarization structures. For such devices, two transparent plates are coated with a photosensitive film and assembled at a well defined distance from each other. The assembly is then exposed to the coherent interference pattern. The two cured photosensitive films have a surface structure that represents a cross section of the interference pattern present during exposure. The space between the plates is then filled with a nematic liquid crystal material. The crystals in the material use the surface structure of the two cured photosensitive films as an alignment layer to form a switched holographic polarization structure.

When an electric field is applied across the material, the crystals align themselves to this field thereby destroying the holographic polarization structure. When the electric field is removed, the crystals realign themselves in the original directions and the holographic polarization structure is again established.

Fixed and switched holographic polarization structures can be fabricated in large areas. Target specifications for multiplication factors, divergence factors, deflection angles and deflection efficiencies can be attained during the recording process by choosing appropriate recording light conditions.

3. Switched Beam Multiplier Description

It is an objective of this invention to use switched holographic polarization structures as switched beam multipliers in LED lighting assemblies to control the illumination field. Switching is provided by applying a voltage across the liquid crystal material using transparent electrodes, and a zone controller.

FIG. 7A shows an embodiment of a switched beam multiplier with a multiplication factor of two, a non-zero divergence factor and zero deflection angle, using a switched holographic polarization structure. For illustration purposes only, the components are shown spread apart. Plates 510 have deposited on one side photosensitive polymer films that are treated to act as alignment layers for the liquid crystals. Liquid crystal material 500 is filled in the space between the alignment layers 810 and 820. This assembly is exposed to an interference pattern generated by two circular polarized light waves, one a plane wave and the other a spherical wave, with parallel propagation axes. After curing a switched holographic polarization structure is obtained. In a switched beam multiplier application, unpolarized incident LED beam 100 is deflected into a circularly polarized diverging beam 110 and an opposite circularly polarized converging beam 120. When a control voltage is applied to transparent electrodes 610 and 620 trough connecting wires 710 and 720, the holographic polarization structure in liquid crystal material 500 is erased. Without the holographic polarization structure, incident LED beam 100 passes through the switched beam multiplier without deflection. When the control voltage is turned off, liquid crystal material 500 reestablishes the holographic polarization structure.

FIG. 7B shows an embodiment of a switched beam multiplier using two fixed holographic polarization structures and a half-wave liquid crystal switch. Fixed holographic polarization structures 830 and 840 on transparent plates 510 each provide a multiplication factor of two, zero divergence factor and non-zero deflection angles. The space between plates 510 is filled with liquid crystal material 500 and dimensioned to introduce a half wave retardation between orthogonally polarized light components. Transparent conducting electrodes 610 and 620 are deposited on the plates. With an incident unpolarized LED beam, first holographic polarization structure 830 generates two orthogonally polarized deflected beams 111 and 121 propagating at a first deflection angle. After passing through liquid crystal material 500, the circularly polarized deflected beams are deflected a second time by second fixed holographic polarization structure 840.

When the control voltage applied to transparent electrodes 610 and 620 is zero, deflected beams 111 and 121 passing through the half-wave plate change their polarization state to the opposite direction, beams 112 and 12, causing the deflection angles of fixed holographic polarization structures 830 and 840 to add. The switched beam multiplier generates two orthogonally polarized deflected beams 110 and 120, shown in the upper part of FIG. 7B. When an appropriate voltage is applied to the transparent electrodes, the half-wave retardation in liquid crystal material is eliminated causing the deflection angles introduced by fixed holographic polarization structures 830 and 840 to subtract. When both fixed holographic polarization structures have the same deflection angles, the switched beam multiplier passes incident LED beam 100 without changing direction as shown in the lower part of FIG. 7B.

According to the invention, switched beam multipliers can be used to provide multiple-LED lighting assemblies with various modes of operation. In switched beam multiplier applications, the switched beam multiplier may be partitioned into one or more multiplier zones. Each multiplier zone is defined by a set of transparent electrodes and control leads for controlling the zone. A zone controller is electrically connected to the plurality of zone leads providing control voltages. By switching control voltages for one or more of the multiplier zones on or off, the zone controller may thus be used to change the appearance of the multi-LED lighting assembly and the brightness distribution in the illumination field.

The number of zones in a switched beam multiplier depends on the use of the lighting assembly. A single zone may be used to actively control the illumination field of the entire multi-LED source. For example, a switched beam multiplier comprised of two cascaded switched polarization gratings with different grating angles, can provide four modes of operation depending of the switching states of the two gratings.

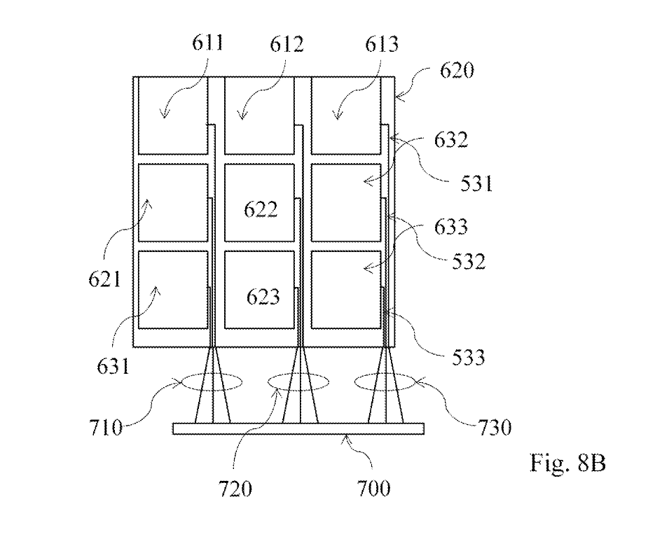

Alternately, zones may be sized to intercept only one of the LED beams for individual control of LED beams or sized to operate on selected groups of LED beams. For example, FIG. 8A shows the electrode 620 for a switched beam multiplier with electrodes 640 and 641, each connected via a control wire enclosed in wire bundle 740 to zone controller 700. In combination with a ground electrode on the second transparent plate, electrode 641 provides control of the perimeter, and zone 640 provides control of the center of the illumination field, respectively.

FIG. 8B shows a second example where the transparent conducting film 620 is patterned into a grid comprising nine zones 611-633 and their control leads. Each thin film electrode is connected via a control lead to a contact pad preferentially at the edge of the switched beam multiplier. In FIG. 8B conducting leads 531, 532 and 533 are shown connected via connecting wires attached to the contact pads to zone controller 700. Wire bundle 730 comprises the connecting wires for conducting leads 531, 532 and 533. Electrodes 611, 612 and 613, as well as, 621, 622 and 623 are likewise connected to zone controller 700 via conducting leads and wire bundles 710 and 720.

One or more transparent ground plane electrodes are patterned on the side of the liquid crystal polarization grating opposite to the electrodes forming the zones. One or more ground planes are also electrically connected to zone controller 700. FIG. 8B provides individual control of nine switched beam multiplier zones, each of which may be operating on at least one or more LED sources.

In other applications, the switched beam multiplier may be partitioned into a number of zones that is larger than the number of LED sources and each LED beam is intercepted by a plurality of individually controllable zones. In these applications, each zone may have a separate or a shared control lead. The plurality of control leads may be mapped 1:1 into a plurality of connecting wires or control leads may be grouped to form non-contiguous groups of zones sharing control wires.

The zone controller may have two dimensional voltage patterns stored in memory. Each voltage pattern activates one mode of operation for the lighting assembly. Voltage patterns may be static or dynamic to provide certain illumination conditions in the illumination field.

Static modes of operation may include a beam sharpening mode, a beam widening mode and a mode that changes the color distribution in the illumination field. In general, the geometry of the desired illumination field determines the cascaded holographic polarization structures best suited for the application. In beam sharpening and beam widening modes, the switched beam multiplier may use one or more concentric holographic polarization structures operating on the LED sources located at the perimeter of the lighting assembly differently than on the LED sources in the center. In a scattering mode of operation, the switched beam multiplier may generate a coordinated or random pattern of deflection angles across the plurality of zones.

For a fixed grating period, the longer wavelength light components of LED beams are deflected into larger deflection angles than short wavelength components of LED beams. This grating dispersion characteristic effects the color distribution in the illumination field. Switched beam multipliers with and without partitioning into multiplier zones may thus be used to implement color distribution modes.

One example for a dynamic voltage pattern is a scanning mode of operation, whereby groups of zones are switched in sequence using a coordinated voltage pattern. Another dynamic mode of operation may use a plurality of random voltage sequences to the switched beam multiplier zones, with a switching rate that is not perceptible to the human eye, effectively generating a dynamic scattering mode of operation.

For selecting modes of operation, the zone controller in the lighting assembly may be comprised of a manually operated switch, or an infrared or radio frequency receiver for remote control.

The invention shall not be limited to the particular examples of switched beam multipliers or modes of operation given above. The method of using switched beam multipliers in combination with a zone controller may be applied to create a wide range of other modes of operation in multi-LED lighting assemblies.

What is claimed:

1. A beam multiplier for use in lighting assemblies using one or more light emitting diode (LED) sources for transmitting LED beams, comprising one or more cascaded holographic structures for controlling the illumination field.

2. A beam multiplier as in claim 1, whereby the one or more cascaded holographic structures operate on at least one incident LED beams of the lighting assembly by generating deflected beams.

3. A beam multiplier as in claim 2, whereby the one or more cascaded holographic structures are characterized by a multiplication factor, an orientation, a divergence factor, a deflection angle and a deflection efficiency.

4. A beam multiplier as in claim 3, whereby the one or more cascaded holographic structures comprises a one-dimensional periodic spatial modulation for generating deflected beams propagating at deflection angles.

5. A beam multiplier as in claim 4, whereby two or more cascaded holographic structures with one-directional periodic spatial modulations have their orientations rotated with respect to each other to provide the function of a multi-directional periodic structure.

6. A beam multiplier as in claim 3, whereby the one or more cascaded holographic structures comprises a concentric spatial modulation for generating focused and defocused deflected beams.

7. A switched beam multiplier as in claim 3, whereby at least one of the cascaded holographic structures is a switched holographic polarization structure with electrodes for providing switching of the illumination field.

8. A switched beam multiplier as in claim 7, whereby the at least one switched holographic polarization structure comprises at least two cascaded fixed holographic polarization structures and at least one liquid crystal polarization switch with electrodes.

9. A switched beam multiplier as in claim 7, whereby the at least one holographic polarization structure comprises a liquid crystal material and electrodes for switching the holographic polarization structure on or off by applying control voltages.

10. A switched beam multiplier as in claim 7, further comprising a zone controller connected to electrodes by conducting leads providing control voltages to the switched holographic polarization structure.

11. A switched beam multiplier as in claim 10, whereby at least one of the electrodes is patterned to from a plurality of beam multiplier zones with conducting leads for electrical connections to the zone controller.

12. A switched beam multiplier as in claim 11, whereby one or more beam multiplier zones share conducting leads for electrical connections to the zone controller.

13. A switched beam multiplier as in claim 12, whereby beam multiplier zones operate on one or more incident LED beams.

14. A switched beam multiplier as in claim 10, whereby the zone controller applies one or more static zone control voltage patterns to the plurality of beam multiplier zones corresponding to static modes of operation.

15. A beam multiplier as in claim 14, whereby one of the static modes of operation is a beam sharpening mode.

16. A beam multiplier as in claim 14, whereby one of the static modes of operation is a wide-angle mode.

17. A beam multiplier as in claim 14, whereby one of the static modes of operation is a color distribution mode.

18. A beam multiplier as in claim 11, whereby the zone controller applies time varying voltage patterns to the plurality of beam multiplier zones corresponding to dynamic modes of operation.

19. A beam multiplier as in claim 18, whereby the time varying voltage patterns are random voltage patterns changing at a rate that is imperceptible to the human eye.

20. A beam multiplier as in claim 18, whereby the time varying voltage patterns are coordinated in time providing a beam scanning mode of operation.

21. A beam multiplier as in claim 10, whereby the zone controller cooperates with an LED source controller controlling the brightness of the one or more LED sources to effect a plurality of modes of operation.
